(19) United States
(12) Patent Application Publication
(10) Pub. No.: US 2011/0109412 A1
(43) Pub. Date: May 12, 2011

(54) Three phasecontinuous flux path transformer core and method of manufacture

(76) Inventor: Jurgen Klaus Vollrath, Indian Trail, NC (US)

(21) Appl. No.: 12/925,789

(22) Filed: Oct. 29, 2010

Related U.S. Application Data
(60) Provisional application No. 61/280,068, filed on Oct. 29, 2009.

(51) Int. Cl. H01F 30/12; H01F 27/25

(52) U.S. Cl. 336/12; 336/213

(57) ABSTRACT

In a three phase wound transformer core three frames are connected in triangular fashion, each frame being made of multiple rings wound in off-set fashion on a common axis.

This application claims priority from U.S. Provisional Patent Application 61/280,068 to Jurgen K. Vollrath, filed Oct. 29, 2009.

### FIELD OF THE INVENTION

The present invention relates to transformer designs. In particular it relates to transformers with a continuous flux path.

### BACKGROUND OF THE INVENTION

Transformers operate on the principle that when an alternating current is passed through a conductor, a changing magnetic field is generated that encircles the conductor. By arranging two wires in proximity to each other and passing an alternating current through one of the wires, the changing magnetic field couples with the second wire or conductor and an alternating current is induced in the second wire by an effect known as electromagnetic induction. By winding the wires into coils and placing them along a common axis the amount of electromagnetic coupling and thus the amount of induced current will be increased compared to straight, parallel wires. The coupling is increased yet further by placing a ferromagnetic substance, referred to as a core, within the coils.

Over time cores have been improved to minimize losses. In the case of low frequency applications, in order to reduce eddy currents, which cause heat losses, steel cores are typically implemented in layers. At higher frequencies, above the audio frequency range, the benefits of laminated steel cores are however overtaken by hysteresis losses, making powdered iron cores more attractive.

The present application deals specifically with low frequency applications, in particular with power transformers used in the national grid (typically 50-60 Hz). The application therefore focuses specifically on laminated magnetic cores, and in particular three phase power transmission and distribution.

Three phase power is typically provided by making use of two sets of three coils or windings each, the primary set of windings being connected to the power supply and the secondary set of windings to the load. The windings in each set is either connected in a delta connection (FIG. 1 A) or a wye connection (FIG. 1B).

A variety of core configurations have been developed over the years, including the flat stack such as the E-core, as shown in FIG. 2, which includes a three-legged section 200 in the form of an E and a bar section 202 that closes the open side of the E-section. The various sections of the core are formed by cutting and stacking steel plates on top of one another.

E-cores are universally used at 50 and 60 Hz and implemented in either shell-wound configuration (primary and secondary windings wound on top of each other around the middle bar or leg 204) or core-wound configuration (the primary and secondary windings are wound around the top leg 206 and bottom leg 208, respectively).

Another core configuration, which for convenience will be referred to as a continuous flux path configuration, involves the use of wound magnetic strip material that defines a continuous flux path. One such configuration, known as the hexaformer configuration is shown in FIG. 3. The hexaformer core configuration is described in greater detail in U.S. Pat. No. 6,683,524. It comprises three frames 300, each made up of three metal rings. Each ring is made of wound layers of magnetic strip material in which the layers are off-set relative to each other to define a ring with a frusto-conical end. In cross-section the ring has a parallelogram shape with inside angles of 60 degrees and 120 degrees. By placing the three rings inside one another and angling them relative to each other, the resultant frame 300 can be forced into engagement with the other frames 300 to define three vertically extending legs 302 located at the corners of a triangle and extending substantially perpendicular to the plane of the triangle with yokes 304, 306 connecting the legs 302 at the top and bottom. As is evident from FIG. 3, the two sets of yokes at the top and bottom have a substantially triangular shape. The particular configuration, shown in FIG. 3, involving 3 loops per frame 300 results in core legs 302 having a substantially hexagonal cross section. It will therefore be appreciated that each frame 300 defines a top and a bottom yoke and two half-legs or leg sections so as to form completed legs when connected to adjacent frames, thereby defining a continuous flux path.

The Hoglund U.S. Pat. No. 6,683,524 distinguishes itself over prior art such as U.S. Pat. No. 4,557,039 to Manderson by the fact that the three phase core of Manderson makes use of wound strips of magnetic material in which the width of the strip tapers from one end of the strip to the other. Manderson thus requires the magnetic strip material to be cut lengthwise at an angle to form a long thin wedge-shaped strip of material. Hoglund, in contrast, does not require such slitting of the material, which Hoglund describes as wasteful and a difficult and time-consuming process. Also, Hoglund distinguishes itself from Manderson in that the abutting surfaces of the frames of Manderson are essentially flat, and therefore the ring-shaped parts of the core are not self-supporting and tend to move relative to one another.

However, the hexaformer core configuration of Hoglund is not without its problems. Since the rings of each frame are angled relative to one another, in other words their rotational axes are not aligned with each other but are angled relative to one another, it is difficult to assemble the three rings to define the frame, and to retain them in this configuration while subsequently assembling the core by meshing the multi-faceted surfaces of the three frames with one another.

Yet another wound three phase core configuration is that described in International Patent Publication WO 2010/027290 A1 and owned by Minel, which makes use of multiple wound rings wound one on top of the other, some wound in off-set mode in which the strip layers are off-set from each other to define an angled step, and at least one ring that is not off-set to define a step that is not beveled and forms a rectangular step. This configuration has the drawback that as the rings are wound on top of each other at a bevel as shown in FIG. 4, supported on an inner rectangular ring 400, the radial forces exerted by the wound strip of some of the rings (rings 402, 404, 406, 408, 410 in FIG. 4) extend past the lateral surfaces of one or more lower rings such as ring 400. As shown in FIG. 4 this has the effect of making the wound set of rings (frame) unstable since the radial forces 412, 414, 416, 418, 420 exerted by the windings of the outer rings 402, 404, 406, 408, 410 act past the outer surface 430 of un-beveled inner ring 400. Thus, in order to avoid the entire frame from toppling over during winding lateral supports would be required to stabilize the rings during winding.

The present invention seeks to provide a new three phase continuous flux path transformer core configuration and method of making such a core, in which some of the difficulties experienced in making the hexaformer core of Hoglund and the cores of Manderson and Minel are addressed to provide a three phase wound core configuration that is easy to make and assemble and can easily be mass produced.

### SUMMARY OF THE INVENTION

For purposes of this application, magnetic material refers to any material that can be magnetized by an electric current flowing near the magnetic material, and includes grain oriented silicon steel, non-grain oriented silicon steel, amorphous metal, or any other material that will support a magnetic field. The term “rotational axis” refers to the axis perpendicular to the diameter of a ring irrespective of whether the ring is initially wound on a circular winding head to define a ring with a circular perimeter or on a non-circular winding head to define a ring with a non-circular perimeter.

According to the invention, there is provided a three phase transformer comprising three frames arranged in triangular fashion, each frame including a plurality of wound rings of magnetic core material, the rings of each frame being wound on a common rotational axis, and each ring being wound from one or more strips of magnetic material of substantially constant width in off-set fashion to define beveled lateral surfaces. Each of the frames may define two substantially straight, parallel leg sections that are secured to the leg sections of two adjacent frames. Each of the rings may comprise multiple layers of at least one of silicon steel or amorphous metal arranged in off-set fashion to define a beveled outer lateral surface and a beveled inner lateral surface. The off-set of the layers of each of the rings in a frame is typically in the same direction and by equal amounts so that the beveled lateral surfaces of the rings have a common angle, typically 60 degrees relative to the rotational axis. The leg sections of any two adjacent frames may be secured to each other by bringing the beveled inner lateral surfaces into abutment to define a core leg and may be secured to each other by means of an adhesive material such as a resin applied to at least one of the abutting beveled inner lateral surfaces of one of the leg sections, and to an outer surface of the leg. The leg sections may further be secured using straps or fiberglass. The fiberglass may comprise fiberglass cloth or fiberglass straps wound around the core legs. Further, according to the invention, there is provided a three phase transformer core comprising three frames arranged in triangular fashion, each frame including a plurality of wound rings of magnetic material, wherein each of the rings comprises multiple layers of magnetic material of substantially constant width, the layers being off-set from one another and the direction of off-set being the same for all of the rings in a frame. For each ring the off-set of the layers preferably defines a beveled surface at an angle of 60 degrees to the rotational axis of the ring. The rings of each frame may be arranged on a common rotational axis.

Further, according to the invention, there is provided a three phase transformer core, comprising three frames arranged relative to each other in delta formation, wherein each frame comprises two substantially straight, parallel leg sections joined by two yoke sections, each leg section abutting a leg section of an adjacent frame to define a leg, each frame including multiple wound rings wherein each ring is wound in off-set fashion from magnetic strip material to define an inner surface, an outer surface, and two beveled lateral surfaces, each ring being arranged so that radial forces exerted by the strip material of a ring does not extend laterally past any of the lateral surfaces of any smaller diameter ring in the frame. Typically each ring comprises multiple wound layers of magnetic material wound in off-set fashion to form beveled lateral surfaces that include a beveled outer lateral surface and a beveled inner lateral surface, wherein the inner lateral surfaces of the rings are preferably aligned with each other to form a substantially continuous beveled surface.

Still further according to the invention there is provided a three phase transformer core, comprising three frames arranged relative to each other in delta formation, wherein each frame comprises two substantially straight, parallel leg sections joined by two yoke sections, the leg sections of adjacent frames abutting each other to define core legs, each frame including multiple rings wherein each ring includes multiple layers of wound magnetic strip material defining an inner surface and an outer surface, the layers being wound in off-set fashion to form a beveled lateral outer surface and a beveled lateral inner surface, the beveled lateral inner surfaces of all of the rings in a frame being arranged to form a substantially continuous lateral frame surface. The substantially continuous lateral frame surface of each frame may define substantially planar abutting surfaces along each of the leg sections, and the abutting surface of each leg section typically abuts an abutting surface of a leg section of an adjacent frame to define a core leg.

The core may further comprise resin and fiberglass material applied to the outer surfaces of the core legs.

### BRIEF DESCRIPTION OF THE DRAWINGS

FIG. 1A is a representation of a delta connection,

FIG. 1B is a representation of a wye connection,

FIG. 2 is a three dimensional view of a prior art E-core,

FIG. 3 is a three dimensional view of a prior art hexaformer core,

FIG. 4 is a of sectional view through one leg section of a prior art Minel core frame

FIG. 5 is a three dimensional view of one embodiment of a transformer core of the invention,

FIG. 6 is a sectional view along line A-A of FIG. 5,

FIG. 7 is a sectional view through one leg section of another embodiment of a frame of the invention,

FIG. 8 is a of sectional view through one leg section of yet another embodiment of a frame of the invention,

FIG. 9 shows an outline view of a frame of one embodiment of the invention,

FIG. 10 shows one embodiment of a winding head of the invention,

FIG. 11 shows an embodiment of a take-off machine of the invention,

FIG. 12 is a section of a frame leg section showing an embodiment of support rods for the legs section of a frame,

FIG. 13 shows an embodiment of a clamp for holding the support rods,

FIG. 14 shows a depiction of a tight rope cable,

FIG. 15 shows a clamp for clamping together a core leg, with the core leg shown in sectional view within the clamp, and

FIG. 16 shows one embodiment of a clamp for clamping one embodiment of a frame of the invention.

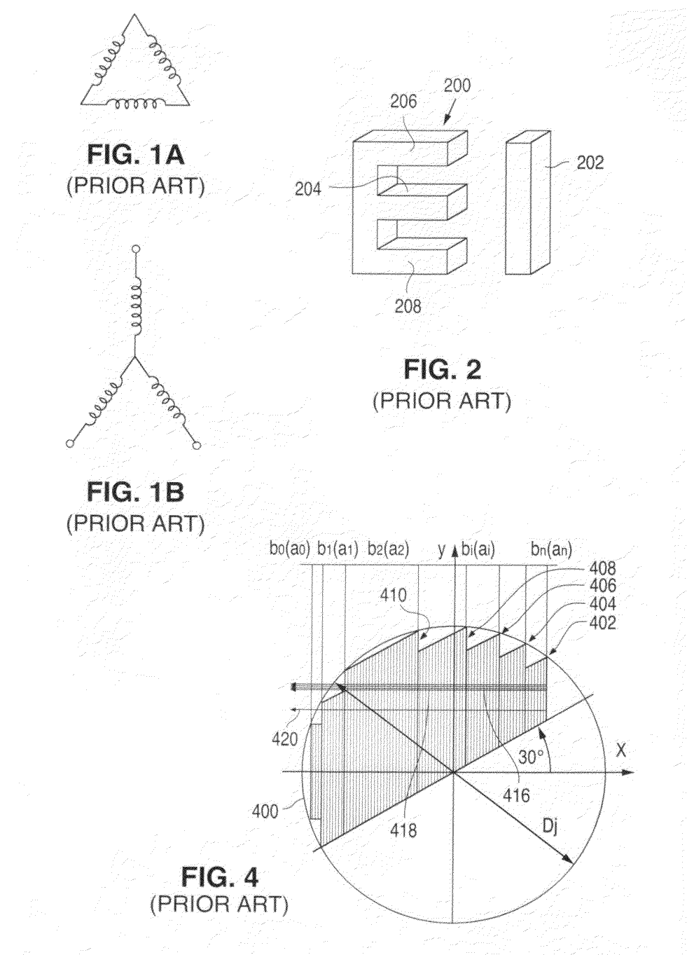

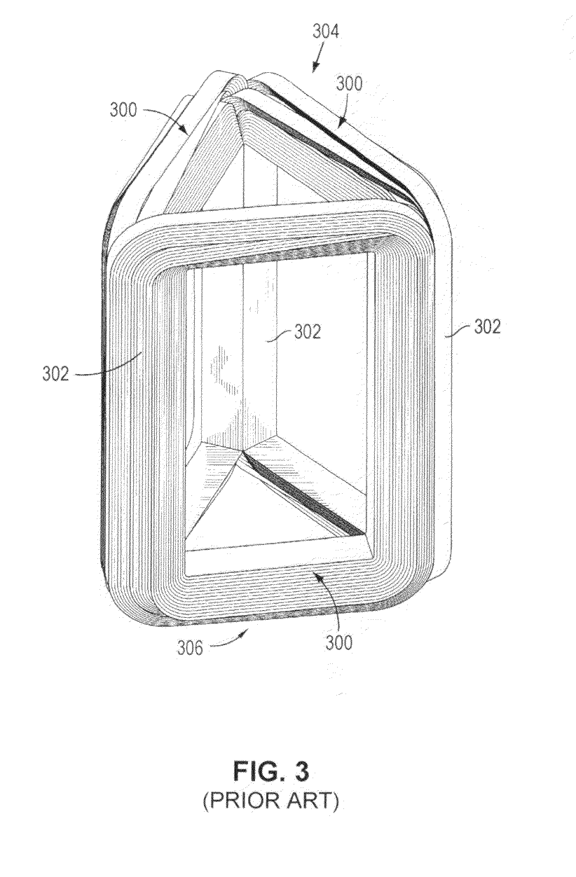

### DETAILED DESCRIPTION OF THE INVENTION

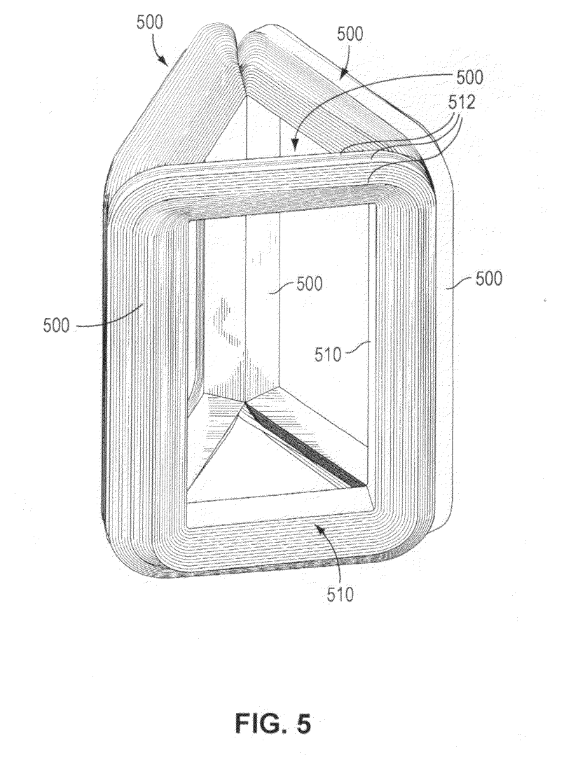

As shown in FIG. 5, the final core of the present invention looks similar to the core proposed by Hoglund and Manderson, in that it provides three frames 500 each made of multiple rings 502 and defining three core legs 504 arranged at the corners of a triangle, and each with a substantially hexagonal cross-section.

However, unlike Manderson the core of the present invention avoids the use of a tapered magnetic strip by instead making use of multiple wound rings wound at an off-set to define multiple tapered rings. The frames making up the core of the present invention each include a primary inner ring 510 and multiple secondary rings 512. The present invention also avoids the use of frames made up of multiple rings that are angled relative to each other as proposed by Hoglund, which requires the frames to be forced into engagement with one another to ensure that the multi-faceted abutting surfaces mesh together. In contrast, the present invention has all of the rings in a frame share a common rotational axis, which allows the frames to be connected more easily as will be discussed in greater detail below. This has the beneficial effect of avoiding unnecessary stressing and damaging of the magnetic material. Stressing of magnetic material typically causes the magnetic properties of the material to deteriorate. One approach, in the past, adopted to dealing with the damage caused to magnetic material during manufacture of transformer cores, has been to anneal the material by exposing it to high temperatures in ovens. This adds additional process steps, that add not only time but cost due to the large amount of energy required in annealing the magnetic material.

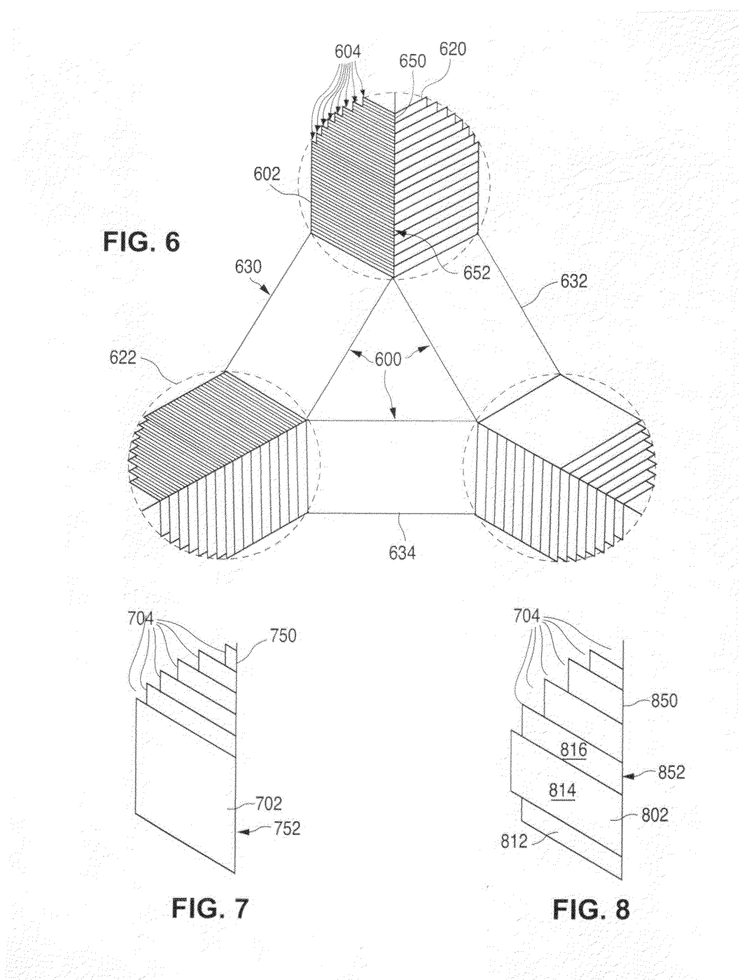

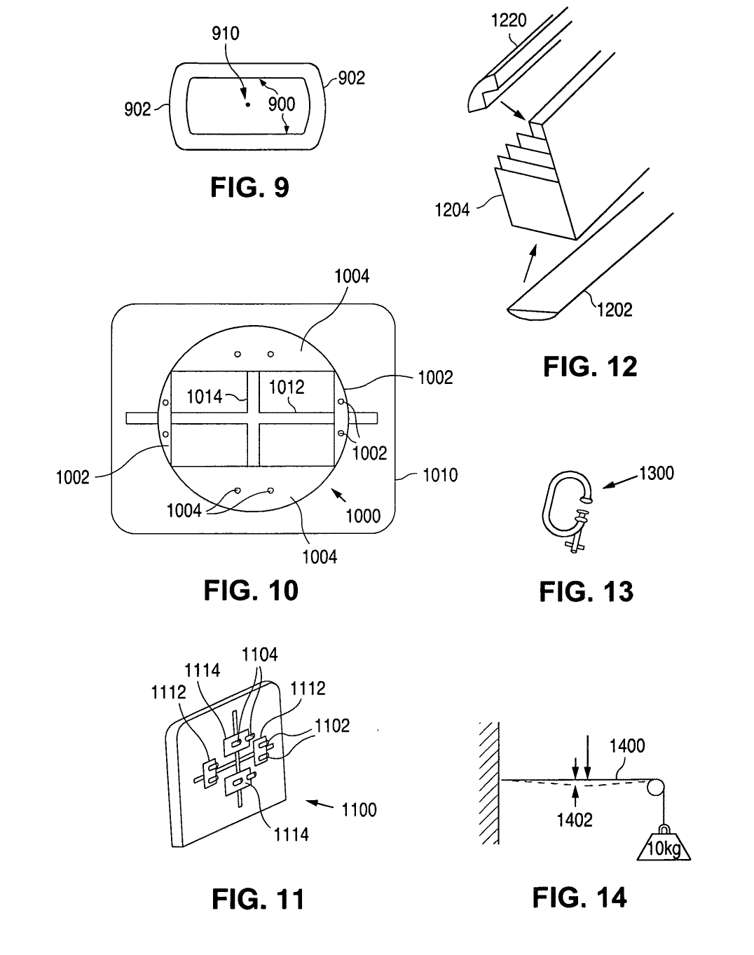

The present invention can better be appreciated with reference to FIG. 6, which shows three frames 600, each made of a primary or main ring 602 that is wound in off-set fashion to define a parallelogram cross-sectional shape with inside angles of 60 degrees and 120 degrees. Each frame further includes at least one secondary ring 604 that is also wound in off-set fashion, each being off-set in the same direction as the primary ring 602. In this embodiment 7 secondary rings are included. The secondary rings 604 are chosen to preferably fill as much as possible of one half of the circumscribed circle, which is depicted by circle 620 in FIG. 6 and which circumscribes a cross-section through two abutting frames, which join to form a core leg. It will be appreciated that the frame 630 is shown in cross-section at two locations, one at circle 620 (where it forms a core leg with frame 632) and one at circle 622 (where it forms a core leg with frame 634). For ease of illustration only the details of the cross sections of frame 630 are shown while the cross sections of the other two frames 632, 634 show only some of the layers of wound magnetic material. In order to maximize the amount of magnetic material in the circles 620, 622, 624 that circumscribe each of the three legs of the core, the secondary rings are chose to have a width and build (thickness) that will cause the outer edge of the outer beveled surfaces of the rings to touch the imaginary circumscribed circle. As shown in the embodiments of FIGS. 6, 7, and 8, typically multiple secondary rings 610, 710, 810, either of substantially similar build (thickness) as shown in FIGS. 6 and 7, or of different build as in the embodiment of FIG. 8, are formed on top of the main ring 602, 702, 802. The main ring 602 and secondary rings 604 can be wound separately and then placed inside one another, or are preferably wound on top of one another to maintain substantially constant tension of the magnetic strip material throughout the frame. However, in both cases the primary and secondary rings in a frame are all centered on a common rotational axis, which is depicted in FIG. 9 by the point 910.

As is evident from the embodiments of FIGS. 6-8 one of the off-set or beveled sides of each of the secondary rings is arranged to extend along the same surface 650, 750, 850 defined by the beveled inner surface 652, 752, 852 of the main ring. This surface thus defines a continuous beveled frame surface, which along the straight leg sections 900 of the frame define substantially planar abutting surfaces for abutting leg sections of adjacent frames. The configuration of the core of the present invention also lends itself to the use not only of silicon steel as the magnetic core material but also amorphous metal. The thin, floppy nature of amorphous metal typically presents particular difficulties in the making of transformer cores. Amorphous metal thicknesses are of the order of 1/1000 inch and even multiple layers of the material stacked on top of one another are significantly less rigid than layers of grain oriented silicon steel or non-grain oriented steel stacked to a similar thickness.

FIG. 9 shows a core frame wound around rotational axis 910. The frame defines two substantially straight, parallel leg sections 900 joined at their ends by yokes 902.

FIG. 10 shows a winding head 1000 made of 4 sections that are slidably mounted on a support plate 1010 that slidably supports the 4 sections in slots 1012, 1014. The rounded sections 1002 support the portions of the frame that will define an upper and a lower arc forming the yokes of the frame. The sections 1004 take the form of flat bars that support the leg sections of the frame. In the embodiment shown in FIG. 10, the rounded and flat sections 1002, 1004 are provided with holes 1012, 1014, respectively, for removing the winding head together with the rings using a take-off tool 1100 as shown in FIG. 11 and as is discussed below.

The take-off tool 1100 is provided with take-up pins 1102 sized complementarily with the holes 1012 in the rounded sections. It will be appreciated that the machine 1100 is not drawn to the same scale as the winding head 1000. The pins 1102 are mounted on plates 1112 that are moveable inward to ultimately release the frame. The tool also includes take-up pins 1104 sized complementarily with the holes 1014 in the large sections. The pins 1104 in this embodiment are also mounted on plates 1114 that are moveable inwardly. In one embodiment, once the take-off tool has removed the winding head sections and core frame from the winding machine, the plates 1114 are moved inward to expose the substantially straight leg sections. Brackets or rods 1200, 1202 running substantially the length of the leg sections and abutting the inner and outer ring layers as shown in FIG. 12 are then secured to the leg sections of the core frame. In this embodiment the brackets are made of a non-magnetic material rated to withstand any subsequent annealing temperatures (approximately 300-350 degrees C. for amorphous metal). The profiles of the brackets, in this embodiment, are chosen to be curved on the outside to enhance the final substantially circular cross section of the legs once assembled. Since the secondary rings discussed with respect to FIGS. 6-8 had their outside edges extending to the circumscribed circle, it will be appreciated that the rod 1200 would, in such embodiments extend outside the circle. Therefore in embodiments where the rod 1200 is to remain attached to the core leg, the outermost secondary ring is preferably adjusted in its dimensions to ensure that the rod 1200 also remains within the circumscribe circle in order not to impede a winding tube that will subsequently have to be mounted on the leg to wind the transformer coils. It will also be appreciated that although the bracket 1200 in this embodiment is designed to press down on the leg section of the two outermost secondary rings, the inner profile of the rod can have further steps to allow it to press down on additional secondary rings and even on the outer edge 1204 of the primary ring

The brackets or rods 1200, 1202 can be retained in place permanently using straps or can be are clamped in place temporarily while the core is coated with a resin to hold the core together. In one embodiment G-clamps 1300, as shown in FIG. 13 are used, thereby pressing the layers of the rings together and retaining the rings in their re-shaped configuration while the resin cures. The purpose of the brackets or rods clamped to the leg sections is also to press the layers of magnetic material together to reduce noise in the final transformer core. The need for this will be appreciated from the analogy to a tight rope 1400 at a tension of 100 N as depicted in FIG. 14. If the length of the cable is 100 cm and is depressed in the center by an amount causing the 10 kg weight to move up by 2 cm then the increase in length of the cable is 2 cm. In other words the corresponding vertical deflection 1402 is SQRT (51²−50²)=10.05 cm, which is approximately 5 times larger than the increase in length. Thus a much lower force is required to deflect the cable than is required to lift the 10 kg weight. By the same analogy, a much lower force is required to separate the layers of a wound ring than the tension on the ring layers. Therefore to avoid vibration between layers during operation of the transformer, it is desirable to manually force the layers of magnetic material together in the leg sections.

In one embodiment, after annealing, a resin impregnated fiberglass wrap or banding tape such as that supplied by Fibertek Inc. of Franklin, Tenn. under the trade name RES-I-GLAS, is wrapped around the leg sections and cured to maintain the compressive pressure on the legs. In one embodiment the rods 1200, 1202 remain secured to the legs and the wrap is wrapped around the leg sections and brackets. In another embodiment, the banding tape is applied without the rods. In yet another embodiment two of the frames are first placed in abutting relationship with one another and the entire leg sections of the two abutting frames are then wrapped with the banding tape. The banding tape thus not only places pressure on the rods 1200, 1202 but also secures the leg sections of adjacent frames to one another. Instead of banding tape, resin can be separately applied to the core and fiberglass tape or cloth applied to the core so that the resin impregnates the fiberglass tape or cloth.

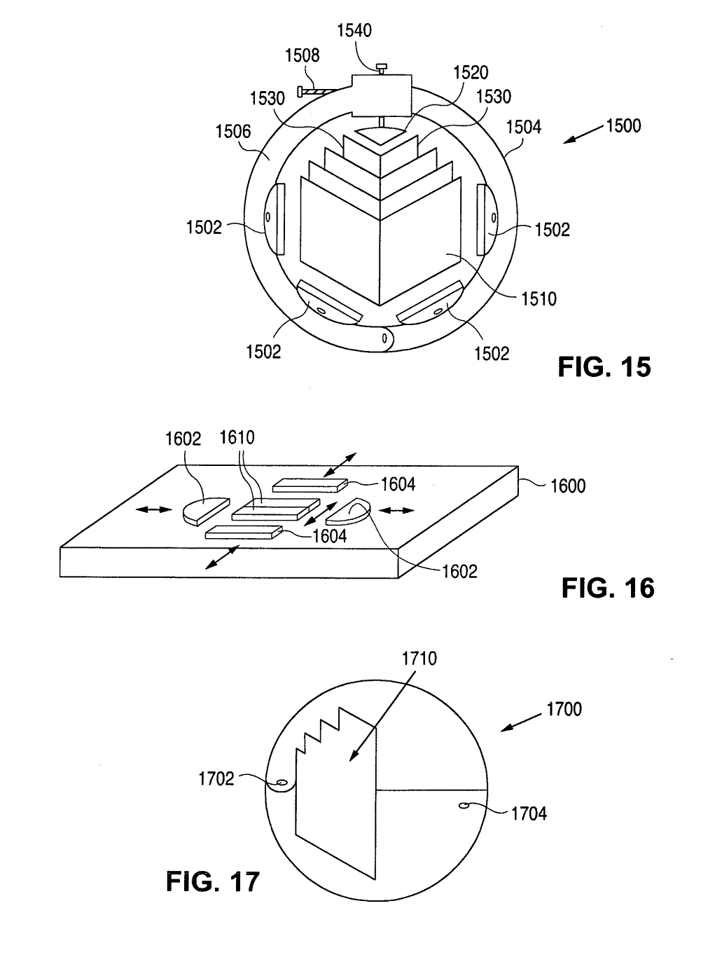

As an added compressive force on the core layers in the legs and to further secure the frames together clamps 1500, such as those shown in FIG. 15 can be secured to the ends of the legs. The clamp 1500 shown in FIG. 15 includes multiple shoes 1502 that press against outer surfaces of the primary rings 1510 when the support frames 1504, 1506 are screwed together by screw 1508. A vertically acting shoe 1520 complementarily engages and presses down on the outermost secondary rings 1530 when the shoe 1520 is moved downward using screw 1540.

The clamps 1500 are preferably provided with a smooth inner surface to act as lateral guides for winding tubes that are subsequently attached around the core legs for purposes of winding the transformer coils onto the core legs.

In one embodiment, to help retain the final shape of the frame prior to connecting to the adjacent frames, each frame is immersed, sprayed, or otherwise covered with a resin having a modulus of elasticity sufficient to accommodate requisite temperature changes of the particular transformer core. Instead, the resin can be chosen to have a thermal expansion similar to the amorphous metal.

In one embodiment the leg sections are held together by means of resin, applied between the abutting surfaces of the straight leg sections and covering the resultant core legs. The resin is preferably supplemented with fiberglass arranged around the legs. e.g., fiberglass straps can be wound around the legs as discussed above to provide additional tensile strength. As mentioned above, in one embodiment, resin impregnated banding, also referred to as stator banding is wound around the core legs.

In order to help the yokes retain their shape, resin or stator banding can also be applied to the yokes and can be supplemented during the resin curing process with clamps such as those shown in FIG. 16 to compress the layers of wound material. In this embodiment, the clamp 1600 comprises a clam shell construction with an inner opening 1610 having a profile corresponding to that of a ring that is to be clamped. It will be appreciated that the profile will vary depending on the size of the frame and number of secondary rings. Clamp 1600 is pivotally connected at pivot point 1602 and the two open ends overlap to allow them to be locked in place by means of a pin 1604.

While the present invention has been described with respect to particular embodiments of the core configuration and particular ways of forming the frames and the final transformer core, the invention is not limited to these embodiments and can be implemented in different ways without departing from the scope of the invention as it is defined in the claims.

What is claimed is:

1. A three phase transformer core comprising
three frames arranged in triangular fashion, each frame including a plurality of wound rings of magnetic core material, the rings of each frame being wound on a common rotational axis, and
each ring being wound from one or more strips of magnetic material of substantially constant width in off-set fashion to define beveled lateral surfaces.

2. A transformer core of claim 1, wherein each of the frames defines two substantially straight, parallel leg sections that are secured to the leg sections of two adjacent frames.

3. A transformer core of claim 2, wherein each of the rings comprises multiple layers of at magnetic strip material arranged in off-set fashion to define a beveled outer lateral surface and a beveled inner lateral surface.

4. A transformer core of claim 3, wherein the off-set of the layers of each of the rings in a frame is in the same direction.

5. A transformer core of claim 4, wherein the leg sections of any two adjacent frames are secured to each other by bringing the beveled inner lateral surfaces into abutment to define a core leg.

6. A transformer core of claim 5, wherein the leg sections are secured to each other by means of an adhesive material.

7. A transformer core of claim 6, wherein the adhesive material is a resin applied to at least one of the abutting beveled inner lateral surface of one of the leg sections, and to an outer surface of the leg.

8. A transformer core of claim 7, wherein the legs are secured with at least one of resin, and fiberglass surrounding the core legs.

9. A transformer core of claim 8, wherein the fiberglass comprises fiberglass cloth or fiberglass straps wound around the core legs.

10. A three phase transformer core comprising
three frames arranged in triangular fashion, each frame including a plurality of wound rings of magnetic strip material, wherein each of the rings comprises multiple layers of magnetic strip material of substantially constant width, the layers being off-set from one another and the direction of off-set being the same for all of the rings in a frame.

11. A core of claim 10, wherein for each ring the off-set of the layers defines a beveled surface at an angle of 60 degrees to the rotational axis of the ring.

12. A core of claim 11, wherein the rings of each frame are wound on a common rotational axis.

13. A three phase transformer core, comprising
three frames arranged relative to each other in delta formation, wherein each frame comprises two substantially straight, parallel leg sections joined by two yoke sections, each leg section abutting a leg section of an adjacent frame to define a leg, each frame including multiple wound rings wherein each ring is wound in off-set fashion from magnetic strip material to define an inner surface, an outer surface, and two beveled lateral surfaces, each ring being arranged so that radial forces exerted by the strip material of a ring does not extend laterally past any smaller diameter ring in the frame.

14. A core of claim 13, wherein each ring comprises multiple wound layers of magnetic strip material wound in off-set fashion to form beveled lateral surfaces that include a beveled outer lateral surface and a beveled inner lateral surface.

15. A core of claim 14, wherein the beveled inner lateral surfaces of the rings in a frame are aligned with each other to form a substantially continuous beveled surface.

16. A three phase transformer core, comprising
three frames arranged relative to each other in delta formation, wherein each frame comprises two substantially straight, parallel leg sections joined by two yoke sections, the leg sections of adjacent frames abutting each other to define core legs, each frame including multiple rings wherein each ring includes multiple layers of magnetic strip material defining an inner ring surface and an outer ring surface, the layers being wound in off-set fashion to form a beveled lateral outer surface and a beveled lateral inner surface, the beveled lateral inner surfaces of all of the rings in a frame being arranged to form a substantially continuous lateral frame surface.

17. A core of claim 16, wherein the substantially continuous lateral frame surface of each frame defines substantially planar abutting surfaces along each of the leg sections.

18. A core of claim 17 wherein the abutting surface of each leg section abuts an abutting surface of a leg section of an adjacent frame to define a core leg.

19. A core of claim 18, further comprising resin and fiberglass material applied to the outer surfaces of the core legs.
